(19) United States
(12) Patent Application Publication
(10) Pub. No.: US 2013/0083338 A1
(43) Pub. Date: Apr. 4, 2013

(54) PRINTING SYSTEM WITH DEEP SUSPEND MODE

(71) Applicants: Mark A. Fahrenkrug, Waukee, IA (US); B. Mark Hirst, Boise, ID (US); Vincent Skurdal, Boise, ID (US); Kevin John Sigl, Fair Oaks, CA (US)

(72) Inventors: Mark A. Fahrenkrug, Waukee, IA (US); B. Mark Hirst, Boise, ID (US); Vincent Skurdal, Boise, ID (US); Kevin John Sigl, Fair Oaks, CA (US)

(21) Appl. No.: 13/249,810

(22) Filed: Sep. 30, 2011

(51) Int. Cl. G06F 3/12

(52) U.S. Cl. 358/1.13

(57) ABSTRACT

A printing system includes a processor to execute a main control program for the printing system, and at least one memory device to store computer code to be executed by the processor. The printing system further includes a network device to receive network print jobs, and a wake circuit to cause the printing system to enter a deep suspend mode in which the printing system consumes less than about 1W of power, and to cause the printing system to wake from the deep suspend mode in response to a set of wake events.

### BACKGROUND

It is attractive to provide power save modes of operation for printers and other image forming devices during extended periods of inactivity. Such power save modes are modes wherein some components of the image forming device are shut down to provide reduced power consumption. Delivering such “green” products is important in today's market. This is especially true in the laser printer market where environmental factors are top criteria affecting purchasing decisions. Existing solutions typically compromise on usability in order to provide a very low power state, and are not able to wake from all key inputs/outputs (I/Os) while in the very low power state.

For these and other reasons, a need exists for the present invention.

### BRIEF DESCRIPTION OF THE DRAWINGS

FIG. 1 is a block diagram illustrating an imaging system according to one embodiment.

FIG. 2 is a block diagram illustrating the printer shown in the imaging system of FIG. 1 according to one embodiment.

FIG. 3 is a block diagram illustrating power control elements of the imaging system of FIG. 1 according to one embodiment.

FIG. 4 is a diagram illustrating the power architecture of the imaging system of FIG. 1 according to one embodiment.

FIG. 5 is a flow diagram illustrating a method of entering and exiting a deep suspend mode in an imaging system according to one embodiment.

FIG. 6 is a flow diagram illustrating a method of controlling a power state of an imaging system according to one embodiment.

### DETAILED DESCRIPTION

In the following detailed description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

One embodiment is directed to an energy efficient LaserJet printer that includes a hardware/firmware/software (HW/FW/SW) architecture that allows the device to stay in a deep suspend state while idle, and yet still wake from key I/Os to be able to quickly resume multi-function jobs on demand. The HW/FW/SW architecture according to one embodiment allows single and multifunction LaserJet printers to automatically transition to consuming less than one watt of power (an industry-accepted definition for “off”) when idle, yet still wake on demand from all key I/Os that are important to the usability of the device. These features are often referred to as Auto-on/Auto-off, or AOAO for short. The RAM state of the system is preserved in one embodiment, which allows the system to wake extremely fast. This is important in avoiding key network timeouts from drivers and hosts when sending jobs to a device that is asleep.

Many existing products do not support the ability to get under one watt and still be able to wake from key I/Os, such as network jobs, mechanical sensors, etc. Those that do get under this one watt threshold do not typically keep network protocols alive from the overall system perspective (e.g., they can only wake from a magic network packet, and cannot simply send a job from any application over any network print path and have that activity alone wake the device and successfully complete the job). Also these existing products typically cannot wake from many mechanical events (e.g., door or tray manipulation, scanner activity, etc.) other than possibly a single sleep or power key. From a usability perspective, this is much less attractive for a customer to enable and use. If a system technically gets under the one watt definition of “off,” but the user has to physically press a button or rely on a real time clock or custom software to get the system to wake, then enterprise customers are much less likely to actually turn on that feature due to the usability issues. In one embodiment, the system disclosed herein is able to enter a less than one watt “off” state (also referred to herein as a “deep suspend mode”), but still be able to wake from key I/Os, including network jobs, control panel interactions, scanner I/O, engine and scanner mechanical activity (e.g., door, trays, lids), and real time clock timers.

In one embodiment, the AOAO feature incorporates the following blocks across the overall HW/FW/SW system design: (1) Network Protocol Proxy—Low power ethernet MAC/PHY contains processor that supports selected network protocols that require frequent responses while the system is in the lowest power state; (2) Network Packet Wake Filtering—Ethernet MAC/PHY provides programmable, extended wake filter engine allowing firmware to load packet filter criteria and produce wake signal events for all necessary classes of ethernet packets; (3) Energy Efficient Ethernet—Support of IEEE 802.3az standard implements low-power idle modes when connection is established with an enabled link partner; (4) PROSAC and Board Design—A custom controller that remains powered and wakes the FW on demand, and provides side band signaling such that the system can not only wake from key network packets, but also control panel, doors, trays, scanner, and facsimile (fax) activity from a walkup user; (5) Suspend to RAM in FW—A custom firmware implementation of suspend-to-ram with support to shutdown specific HW and ASICs; (6) Power Supply Efficiency Enhancements; and (7) User interfaces (UIs) that allow the user to control their energy usage for an individual device or a fleet of devices.

The system according to one embodiment presents a UI that allows the user to select “how green” they want their device to be and “what I/Os” they wish to wake from and “how much performance” they require. It also allows the user to control when the system will transition into an auto-off mode such as via an inactivity timer or at certain times during the day. The system according to one embodiment performs the following: (1) Turns off automatically into a deep suspend state; (2) turns on automatically from all key I/Os; (3) while in the deep suspend state, the system wakes-up based on a user-configurable set of auto-on events; (4) allows the user to set an auto-off delay time to cause the system to automatically enter the deep suspend state based on non activity for the specified time; and (5) the system consumes less than one watt in the deep suspend state.

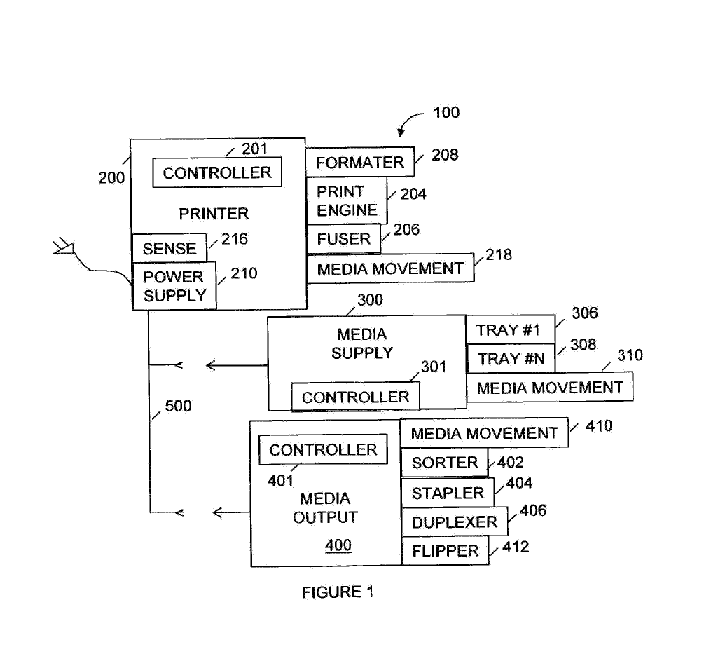

FIG. 1 is a block diagram illustrating an imaging system 100 according to one embodiment. Imaging system 100 may be employed in any one of several environments and image transfer applications such as, for example, office printing and/or copying, industrial printing and/or medical imaging. However, these are merely specific examples of how an imaging system may be used and the claimed subject matter is not limited in these respects. The terms “imaging system” and “printing system” are used interchangeably herein. Such an imaging system or printing system may comprise any one of several apparatuses comprising an imaging device to transfer an image to imaging media.

The terms “configuration” and “operating mode” are referred to interchangeably herein and relate to an operational state of an imaging system. Such a configuration and/or operating mode may be selectable or controlled by a user and/or automatically by a controller. A configuration and/or operating mode of an imaging system may be determined by a state of one or more subsystems of the imaging system. However, these are merely examples of a configuration and/or operating mode and the claimed subject matter is not limited in these respects.

The imaging system 100 is shown with printer 200, an optional media supply unit 300, and an optional media output unit 400. These particular options are merely provided as examples to aid the reader in understanding the disclosed subject matter and the claimed subject matter is not limited in these respects. The imaging system 100 comprises several subsystems such as, for example, a power supply 210, formatter 208, print engine 204, and fuser 206. Media movement 218 may represent motors, gears, and/or diverters that result in the media moving through the printer 200. A sense circuit 216 may sense an input power signal and may also sense the number and/or type of accessories attached to printer 200.

A bus 500 connects accessories to the printer 200. In one embodiment, the bus 500 comprises power and communication channels, however, the claimed subject matter is not limited to such an arrangement. The bus 500 may pass power while data communication is handled through a second I/O channel such as an infrared (IR) channel. Alternatively, the bus 500 may comprise data communications through any number of I/O formats (IR, RF, wires, magnetic coupling, etc.). Power for accessories may come from a source other than the power supply 210 (e.g., directly from a wall outlet). Independent of the structure of bus 500, the sense circuit 216 may monitor the input power signal and relay information characterizing the input power signal to a printer controller 201. The printer controller 201 may then use this information characterizing the input power signal to determine a configuration and/or operating mode for the imaging system 100.

The media supply accessory 300 comprises a controller 301 for communicating with printer 200 and managing proper operation of the media supply 300. Media supply 300 comprises multiple media trays 306-308. A media tray may be designed for high capacity and/or different types or sizes of sheets of imaging media. Media movement 310, as in printer 200, may represent motors, gears, and/or diverters that result in the media moving through the media supply accessory.

The external media output accessory 400 comprises a controller 401 for communicating with printer 200 and managing proper operation of the media output 400. Media output 400 may comprise several operations such as a sorter 402, stapler 404, and/or media movement 410. Duplexer 406 may be part of the media output accessory, or it may be a separate accessory that attaches directly to the printer 200. Flipper 412 may be used to change the orientation of the paper thereby allowing the media output 400 to output either face-up or face-down.

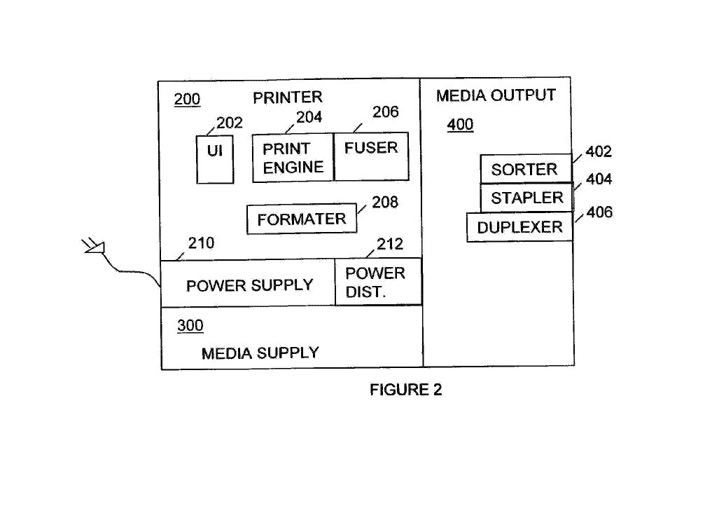

FIG. 2 is a block diagram illustrating the printer 200 shown in the imaging system 100 of FIG. 1 according to one embodiment. The printer 200 may comprise a plurality of subsystems that may draw electrical power for operation, including, for example, a user interface (UI) 202 (which may comprise an input device such as a keypad and/or an output device such as a display), a print engine 204 (to control the physical transfer of images to imaging media), a formatter circuit assembly 208 (which may convert the data received into a format that the print engine 204 uses to create an image on the imaging media), and a fuser 206 (which uses high temperature and pressure to fuse the image onto the imaging media). However, it should be understood that these are merely examples of subsystems in an imaging system that may draw power for operation and that claimed subject matter is not limited in these respects. A power supply 210 converts an input power signal from an electrical outlet into operating voltages for operating the other subsystems of the printer 200. The power supply 210 may be designed such that it can accept a variety of input voltages of a power source. Power distribution 212 is responsible for distributing both power and power information among the subsystems.

While the embodiment shown in FIG. 1 is particularly directed to a laser printer type of imaging device, the claimed subject matter may be applied to other types of imaging systems using other types of image transfer techniques such as, for example, other types of direct thermal imaging, ink jet imaging and/or dye diffusion imaging. It should be understood that while such imaging systems using other types of image transfer techniques may comprise subsystems which are different from those of a laser printer, the claimed subject matter may also apply to these imaging systems.

While not shown in FIG. 1, the imaging system 100, according to a particular embodiment, may comprise a scanner subsystem that is capable of capturing images from a scanned surface to be stored and/or reproduced on imaging media provided by the media supply 300. Such a scanner subsystem may generate image data according to a particular format representing the captured image. By including a scanner, for example, the imaging system 100 may comprise functionality as a copier (e.g., by printing the captured image based, at least in part, on the image data), facsimile machine (e.g., by transmitting the image data over phone lines), or a multi-function printer (MFP). Such an MFP may also comprise an automatic document feeder (ADF) to sequentially feed pages of a document to the scanner for image capture. The imaging system 100 may also be implemented without a printer 200. For example, imaging system 100 may be implemented as a digital sender that scans an input document and sends the scanned document to storage over a network.

Among other things, the printer controller 201 performs several control duties such as, for example, diagnostics, processing input from and providing display information to the UI 202, managing power supplied to the subsystems of the imaging system 100, maintaining maintenance logs, controlling the process speed and/or inter-page gap (thereby affecting throughput), tracking the status of consumables (e.g., toner cartridges), controlling and/or monitoring sensor input signals and/or solenoid output signals and controlling changes in DC power signals.

The printer controller 201 may comprise a microprocessor or microcontroller that is capable of executing machine-readable instructions from a storage medium for performing the aforementioned functions of defining modes of operations. As such, the printer controller 201 may execute machine-readable instructions stored as updateable firmware in a non-volatile memory device (not shown) such as a flash memory device. Alternatively, the printer controller 201 may comprise one or more application specific integrated circuits (ASICs), field programmable gate array (FPGA) devices, application specific programmable devices, and/or any other combination of devices capable of providing logic for performing the aforementioned functions. However, these are merely examples of how logic may be implemented in a printer controller and claimed subject matter is not limited in these respects.

In one embodiment, imaging system 100 is configured to switch between a plurality of different operating modes. In one form of this embodiment, the operating modes include an On mode, an Off mode, a suspend (or sleep) mode, and a deep suspend (or deep sleep) mode. In the suspend mode according to one embodiment, imaging system 100 consumes slightly more than 1 W of power, and in the deep suspend mode, imaging system 100 consumes less than 1 W of power. Despite the low power consumption in the suspend mode and the deep suspend mode, imaging system 100 is still able to wake up in response to all key input/output (I/O) events, and automatically transition into the On mode in response to such an event.

System 100 can enter the Off mode by pressing a power switch to an Off position, and can enter the On mode by pressing the power switch to an On position. System 100 can be programmed by a user for a “scheduled sleep,” in which the system 100 automatically transitions to the suspend mode at a set time. System 100 can be programmed by a user for a “scheduled wake,” in which the system 100 automatically transitions to the On mode from the suspend mode at a set time. System 100 can be programmed by a user for a “scheduled off,” in which the system 100 automatically transitions to the deep suspend mode at a set time. System 100 can be programmed by a user for a “scheduled on,” in which the system 100 automatically transitions to the On mode from the deep suspend mode at a set time. System 100 can be programmed by a user for an “auto off”, in which the system 100 automatically transitions to the deep suspend mode after a user-defined period of inactivity. System 100 can be programmed by a user for an “auto on”, in which the system 100 automatically transitions from the suspend mode or the deep suspend mode to the On mode in response to a wake event.

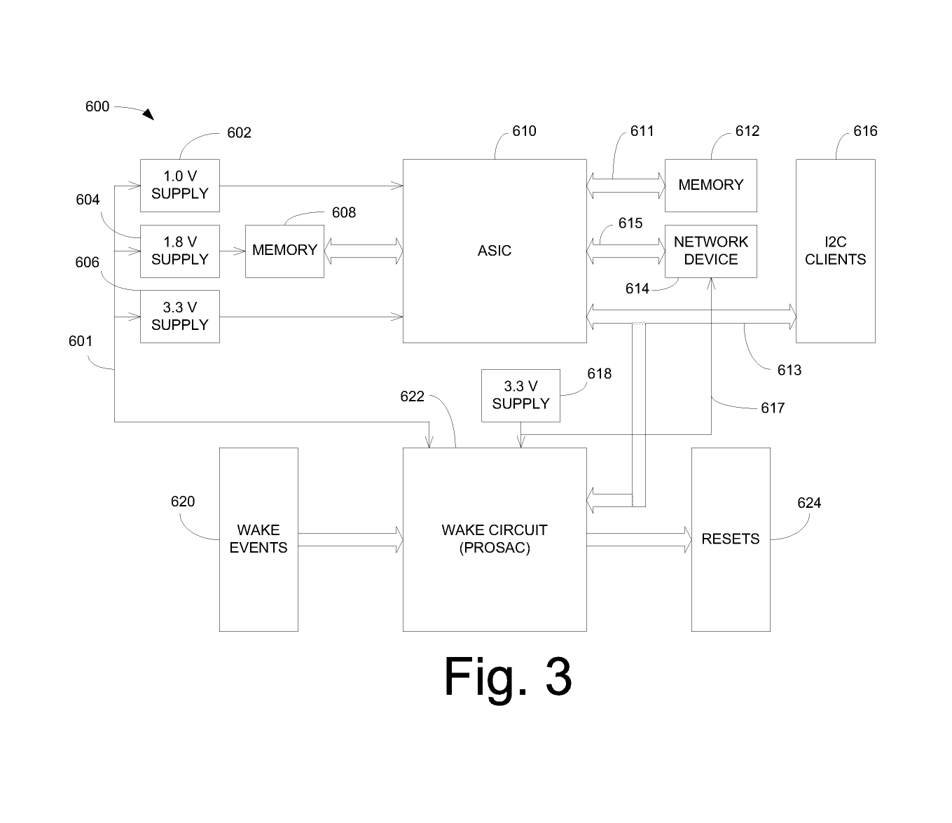

FIG. 3 is a block diagram illustrating power control elements 600 of the imaging system 100 of FIG. 1 according to one embodiment. The elements 600 include power supplies 602, 604, and 606, memory device 608, ASIC 610, memory device 612, network device 614, power supply 618, and wake circuit 622. In the illustrated embodiment, power supply 602 is a 1.0V power supply, power supply 604 is a 1.8V power supply, power supply 606 is a 3.3V power supply, and power supply 618 is a 3.3V power supply. Memory device 608 is a double data rate (DDR) dynamic random access memory (DRAM) in the illustrated embodiment, and memory device 612 is a flash memory device. In the illustrated embodiment, network device 614 is a 10/100/1 G MAC/PHY network device.

Memory device 612 is communicatively coupled to ASIC 610 via communication link 611, which is a serial peripheral interface (SPI) bus in one embodiment. ASIC 610 is communicatively coupled to I2C clients 616 and wake circuit 622 via communication link 613, which is an I2C bus in one embodiment. ASIC 610 is communicatively coupled to network device 614 via communication link 615, which is a one-lane peripheral component interconnect express (PCIe ×1) bus in one embodiment. In one embodiment, ASIC 610 includes a CPU that executes computer code that is stored in memory device 608.

I2C clients 616 according to one embodiment include, for example, a real time clock (RTC) client, a clock generator (CLOCK GEN) client, a non-volatile RAM (NVRAM) client, a dual in-line memory module (DIMM) serial presence detect (SPD) client, an external ASIC (EXT ASIC) client, a security client, and may include other clients. Wake events 620 according to one embodiment include, for example, an RTC event, a scanner event, and LAN event, a fax event, a key press event, an engine event, and may include other wake events. Resets 624 according to one embodiment include, for example, a serial advanced technology attachment (SATA) reset, a peripheral component interconnect express (PCIE) reset, an ASIC reset, a LAN reset, an external ASIC (EXT ASIC) reset, a fax reset, an engine reset, and may include other resets.

Wake circuit 622 according to one embodiment is a low power microcontroller (e.g., consumes about 0.1 watts) that performs a plurality of functions that may be summarized by the acronym “PROSAC”, which represents Power, Reset, Observability, Supervisor, And, Controller. The “Power” portion of wake circuit 622 according to one embodiment means that the wake circuit 622 controls the power state of the various elements of system 100, and the sequence in which these elements are powered on or powered off. The “Reset” portion of wake circuit 622 according to one embodiment means that the wake circuit 622 is able to reset the various elements of the system 100. The “Observability” and “Supervisor” portions of wake circuit 622 according to one embodiment means that the wake circuit 622 is able to monitor the operation of system 100, including reading the state of signals from the ASIC 610, as well as signals from other elements of the system 100. The “Controller” portion of the wake circuit 622 according to one embodiment means that the wake circuit 622 is able to make appropriate decisions based on the observed behavior of the system 100, and control or modify the operation of system 100 based on those decisions.

In one embodiment, ASIC 610 is configured to send commands to wake circuit 622 via I2C bus 613, and thereby indicate to wake circuit 622 the desired power behavior of system 100. For example, such commands might indicate to wake circuit 622 that it should wake up system 100 for certain ones of the wake events 620, but not other ones of the wake events 620.

Wake circuit 622 and network device 614 are powered by power supply 618 via link 617. In one embodiment, as long as imaging device 100 has not been physically powered off, power supply 618 is “always on” and is powering wake circuit 622 and network device 614. Thus, even in the suspend mode and the deep suspend mode, wake circuit 622 and network device 614 are still powered up. In the deep suspend mode according to one embodiment, wake circuit 622, network device 614, and a real time clock (RTC) are essentially the only components of imaging system 100 that remain fully powered up, thereby allowing the system 100 to consume less than 1 W of power. Wake circuit 622 is configured to control power supplies 602, 604, and 606 via communication link 601. In the deep suspend mode, wake circuit 622 turns off one or more of power supplies 602, 604, and 606, which correspondingly powers off the ASIC 610, the memory device 608, as well as other components of the system 100.

In the deep suspend mode according to one embodiment, memory device 608 goes into a self-refresh state, and maintains the state of the CPU in ASIC 610, thereby allowing ASIC 610 to be powered off. The memory device 608 is provided with just enough current to preserve that state information. When system 100 exits the deep suspend mode, the CPU in ASIC 610 is powered back up and is returned to the state indicated by the information stored in memory device 608.

In the deep suspend mode according to one embodiment, the following elements of system 100 are powered off: (1) ASIC 610; (2) scan ASIC; (3) print ASIC; (4) control panel (HW interrupts enable wake); (5) fax (HW interrupts enable wake); (6) scanner; (7) print engine; (8) external paper handling devices; (9) hard disk drive (HDD)/solid state drive (SDD); (10) fans; (11) USB device power; (12) USB host power; (13) 24.0V supply, 12.0V supply, 5.0V supply, and 1.0V supply (3.3V supply is off on formatter and on for engine, and 1.8V supply is on); (14) Khan; (15) HIP; (16) PCIe-SATA bridge; and (17) SATA SSD or HDD.

In the deep suspend mode according to one embodiment, wake circuit 622 and network device 614 monitor received wake events 620, and determine whether to transition from the deep suspend mode to the On mode based on received wake events. Such events may include, for example, a user touching the control panel of the system 100, a user manipulating certain doors or trays of the system 100, a user placing a document on an automatic document feeder of the system 100, a user sending a print job to the system 100, as well as many others. Side band signaling is used in one embodiment to inform the wake circuit 622 of certain wake events 620, such as notifying the wake circuit 622 that a control panel key of a powered down control panel of the imaging system 100 has been pressed.

The suspend mode incorporates the following key blocks across the HW/FW system design: (1) Turning off scan, control panel backlight, suspending all USB devices, fax, scanner, print engine, external paper handling, HDD/SDD spin down, fans, and USB host; and (2) allowing the system to still wake from all I/Os including USB device, network, control panel interactions, scanner I/O, engine and scanner mechanical activity (door, trays, lids), and real time clock.

Network device 614 according to one embodiment includes user-programmable filters to define network events that will be considered wake events that will cause system 100 to wake up. These filters allow system 100 to wake from certain packets that are directed directly to the system 100 (e.g., a print job), and certain network broadcast type packets, as well as magic wake packets.

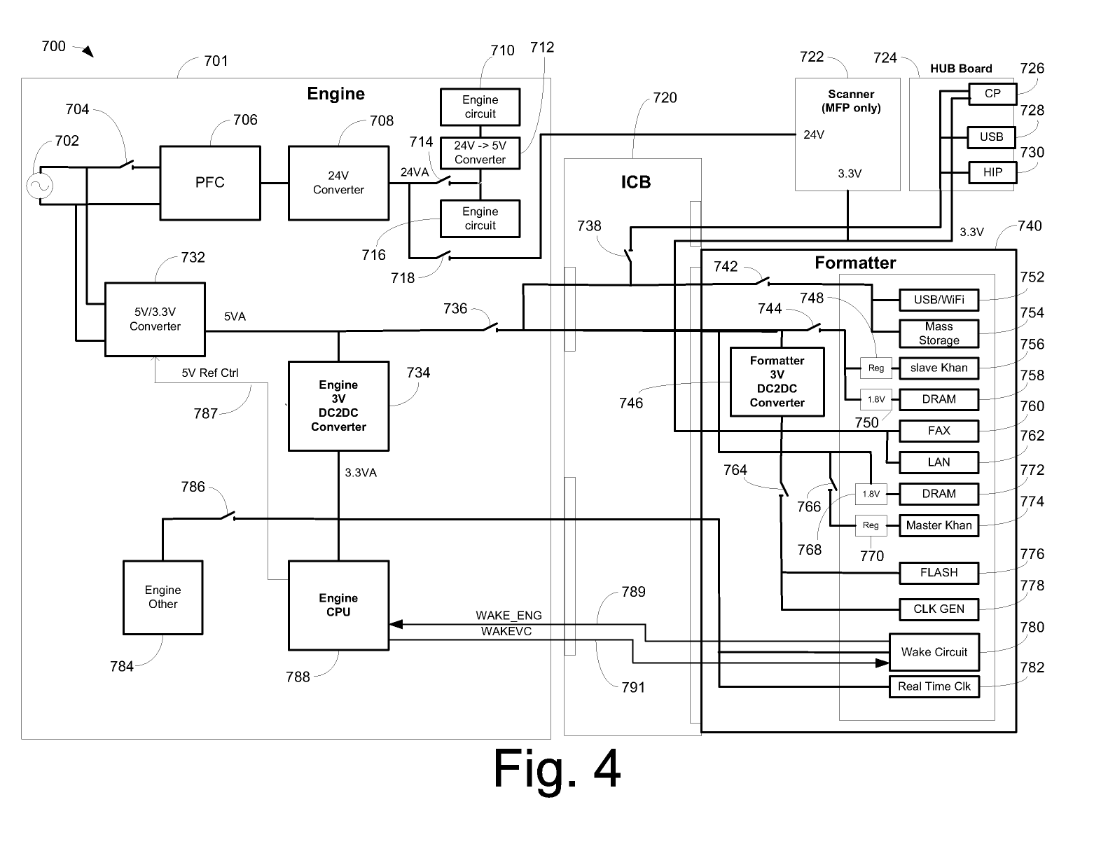

FIG. 4 is a diagram illustrating the power architecture 700 of the imaging system 100 of FIG. 1 according to one embodiment. Architecture 700 includes engine 701, interconnect board (ICB) 720, scanner 722, HUB board 724, and formatter 740. Engine 701 includes AC power supply 702, switch 704, power factor correction (PFC) controller 706, 24V converter 708, engine circuit 710, 24V to 5V converter 712, switch 714, engine circuit 716, switch 718, 5V to 3.3V converter 732, engine 3V DC to DC converter 734, switch 736, other engine circuitry 784, switch 786, and engine CPU 788. ICB 720 includes switch 738. HUB board 724 includes control panel (CP) 726, USB 728, and hardware integration pocket (HIP) 730. Formatter 740 includes switch 742, switch 744, formatter 3V DC to DC converter 746, regulator (Reg) 748, 1.8V power supply 750, USB/WiFi 752, mass storage 754, slave Khan 756, DRAM 758, fax 760, LAN 762, switch 764, switch 766, 1.8V power supply 768, regulator (Reg) 770, DRAM 772, master Khan 774, flash memory 776, clock generator (CLK GEN) 778, wake circuit 780, and real time clock 782. Wake circuit 780 corresponds to the PROSAC wake circuit 622 shown in FIG. 3.

PFC 706 and 24V converter 708 generate a 24 volt supply (24 VA), which is provided to scanner 722, converter 712, and engine circuit 716. Converter 712 converts the 24 volt supply (24 VA) to a 5 volt supply, which is provided to engine circuit 710. In one embodiment, switch 704 is closed in print mode, standby mode, and scan only mode, and is open in power save modes (e.g., suspend mode and deep suspend mode), thereby removing the 24 volt supply (24 VA) from the connected components in the power save modes. Switch 714 is opened for the scan only mode. Switch 718 is closed in scan mode, and is open in standby mode.

Converter 732 is controlled by engine CPU 788 via a 5V Ref Ctrl signal 787 to provide either a 5 volt supply or a 3.3 volt supply. In one embodiment, converter 732 provides a 5 volt supply in the print mode, standby mode, and suspend mode, and provides a 3.3 volt supply in the deep suspend mode and the off mode. The supply line (5 VA) from converter 732 is coupled to converter 734, regulator 748, 1.8V supply 750, converter 746, 1.8V supply 768, regulator 770, USB/WiFi 752, mass storage 754, control panel 726, USB 728, and HIP 730. Switch 736 is closed in the print mode, suspend mode, and deep suspend mode, and is open in the off mode. Switches 738 and 742 are closed in the print mode and suspend mode, and are open in the deep suspend mode and the off mode. Converter 734 provides a 3.3V supply (3.3 VA) to other engine circuitry 784, engine CPU 788, wake circuit 780, and real time clock 782. Switch 786 is closed is print mode, and suspend mode, and is open in deep suspend mode and off mode.

Converter 746 provides a 3.3V supply to fax 760, LAN 762, flash memory 776, clock generator 778, scanner 722, and control panel 726. Switches 764 and 766 are normally closed, but are opened in the deep suspend mode. Switch 744 is opened in some modes to provide further power savings (referred to as “Smart Watt”).

In the power save modes (e.g., suspend mode and deep suspend mode), the 24 volt system is turned off via switch 704, and the 5 volts on the engine 701 is changed to 3.3 volts. The engine CPU 788 remains powered on. Two hardware signals are exchanged between the engine 701 and the formatter 740 (i.e., WAKE_ENG and WAKEVC). The WAKE_ENG signal is provided from the wake circuit 780 to the engine CPU 788 via communication link 789, and indicates that the engine 701 is to wake up. The WAKEVC signal is provided from the engine CPU 788 to the wake circuit 780 via communication link 791, and indicates that the formatter 740 is to wake up. The 1.8 volt supplies 750 and 768 in the formatter 740 are essentially the only power supplies that remain on (to maintain the DRAMs 758 and 772 in a self-refresh state) in the deep suspend mode. The 3.3 volt VA supply from converter 734 provides a small amount of power (e.g., 10 milliwatts) to the wake circuit 780 and the real time clock 782. A small amount of 3.3 volt power is also provided to the scanner 722 (for MPF products) and to the control panel 726 (to be able to sense key presses) from the converter 746. In one embodiment, the control panel 726 includes a circuit configured to perform a key matrix scan, and if any key is pressed, the circuit generates a wake up pulse that is provided to the wake circuit 780.

Operating modes of the engine 701 and the formatter 740 will now be described in further detail, starting with the engine 701. The engine 701 according to one embodiment has five modes of operation: Off, deep suspend, suspend, idle, and print. In all modes, the engine 701 draws some power from the AC power supply 702, and supplies power to a very low power engine CPU 788. Power is also supplied to wake circuit 780 and real time clock 782 in the formatter 740 in these modes. The suspend mode and the deep suspend mode for the engine 701 will now be described in further detail.

In the suspend mode, the engine CPU 788, the main control ASIC, and the majority of sensors in system 100 are powered. The formatter 740 is powered up (e.g., ASICs, memory, mass storage, etc.) in this mode and is in constant communication with the engine 701. Loads turned off include: fans, fusing system, motors, paper cassette sensors, etc. Additionally the backlight on the control panel 726 is dimmed or turned completely off. Many portions of the formatter ASIC that are only used for printing are turned off as well. In the suspend mode, the system 100 is able to respond to most forms of user interaction: door opening, pressing buttons, opening/closing paper cassettes, sending print jobs to any I/O (LAN, USB, WiFi, etc.). As the formatter 740 and engine 701 are in constant communication in the suspend mode, the system 100 is able to wake from sleep to ready and print a page in minimum time.

In the deep suspend mode, a command is sent from the formatter 740 to the engine 701 instructing the engine 701 to enter a very low power mode. The engine 701 turns off all fans, motors and the majority of sensors except those needed to sense certain user interactions. In this case, the engine 701 senses the main door, the power switch, and the WAKE_ENG signal from the formatter 740. If the user opens the main door or presses the power switch, the engine 701 will assert the WAKEVC signal, indicating that there is a wake event and that the system 100 should be powered back up to determine appropriate action to take. In one embodiment, imaging system 100 includes an LED associated with a power switch for the system 100. In normal operation, the LED is on 100% of the time, but in the deep suspend mode, the LED is cycled on and off (e.g., on for about 0.2 seconds and off for about 2.8 seconds). This saves 93.7% of the energy normally used by the LED, indicates to the user that the power switch can be used to wake the system 100, and also functions as a state indicator to indicate a very low power state.

In the deep suspend mode, while most of the engine 701 is off, the power supply to the formatter 740 is left on, enabling the formatter 740 to be in one of several low power states with varying degrees of responsiveness. In one embodiment, the engine 701 supplies +5V and/or +3.3V to the formatter 740, as these voltages are typically used in the industry for digital logic and mass storage. To minimize engine side power consumption, the +5V may be completely turned off or reduced in output voltage from +5V to +3.3V, in which case the converter 734 switches from DC:DC conversion mode of operation to a pass-through mode of operation. Additionally, there are switches on the engine 701 in one embodiment to individually control the +5V and +3.3V supplies to the formatter 740.

Like the engine 701, the formatter 740 according to one embodiment also has five modes of operation: Off, deep suspend, suspend, idle, and print. The suspend mode and the deep suspend mode for the formatter 740 will now be described in further detail.

In suspend mode, the formatter 740 instructs the engine 701 to enter a low power mode where the fuser and cooling fans are turned off. The backlight to the display of the control panel 726 is dimmed or turned off and the mass storage (hard disk or solid state media) enters a slumber mode, greatly reducing power consumption.

In the deep suspend mode, a command from the formatter 740 instructs the engine 701 to turn off most of its systems including the ASIC, fuser, fans, motors, and the communications channel with the formatter 740. The formatter 740 also turns off its communications channel with the engine 701 and enters a low power state. The formatter 740 according to one embodiment has implemented two different types of the deep suspend mode.

The first type of the deep suspend mode allows for complete support of user input and interaction. In the case that the engine +5V drops to +3.3V, there is a boost converter provided on the formatter 740 to maintain a +5V supply to power the hard disk as well as any devices connected to the USB sub-system. In this state, the CPU and main memory remain active and respond to all supported I/Os and user inputs. In this implementation, input is supported from LAN, USB-device, USB-host, WiFi (if installed), user interaction with control panel buttons, power switch press and opening an access door on the printer.

The second type of the deep suspend mode is the lowest possible formatter power state that is still responsive to a print job on the main I/O (e.g., the LAN). To achieve this state of operation, most major subsystems of the formatter 740 are turned completely off. To implement this, the main memory is placed in a self-refresh state and the wake circuit 780 is then issued a command to control formatter side power switches and power supplies, and turn off power to the ASIC, flash memory, clock generator, hard disk, hard disk interface, PCIe interface switches and USB system. The only formatter systems left powered are the memory system (in self-refresh), the LAN, Fax (if installed) and portions of the control panel display. LED indicators for the LAN Link/Activity are turned off or the bias current is dropped to a minimum value to indicate activity while saving as much energy as possible. On multifunction devices, the control panel ASIC and display are completely powered down except for a single button used to wake the system. On single function printers (SFPs), the display backlight is dimmed to a very low level, status indicator LEDs are turned off, and a final message indicating a low power state is written to the control panel display before ending communications with the display. The control panel display has its own low power micro-controller and maintains a readable display with very low power and continues to scan the keyboard in case of a user button press. A side-band signal from the control panel 726 becomes active if a user presses a button and this signal is supplied to the wake circuit 780 to allow the system 100 to exit the deep suspend mode. In the second type of the deep suspend mode according to one embodiment, the system 100 uses from 0.45 W to 0.9 W while still being responsive to a LAN print job and user interaction on the control panel 726, power switch, or opening an access door as well as displaying a readable message on the control panel display.

The wake circuit 780 may be either discrete circuitry or implemented in a low power micro-controller. In one embodiment, signals are supplied to the wake circuit 780 from sensors in the scanner 722, control panel 726 key presses, LAN circuit 762, real time clock 782 alarm output, FAX 760, and the WAKEVC signal from the engine CPU 788.

In one embodiment, a user can program power control settings using the control panel 726. In SFP implementations of system 100 according to one embodiment, three user configurable settings are provided. The first setting controls whether the power savings is enabled or not. The second setting is a timer, such that the system 100 automatically enters a low power state after the user specified time has expired, if no activity occurs during that time period. The third setting controls what state the system 100 goes into when the timer expires (e.g., suspend mode, deep suspend mode, or completely powered off). In one embodiment, system 100 also includes an embedded web server user interface to allow a user to remotely program these user configurable settings via the Internet. In MFP implementations of system 100 according to one embodiment, additional user configurable settings are provided.

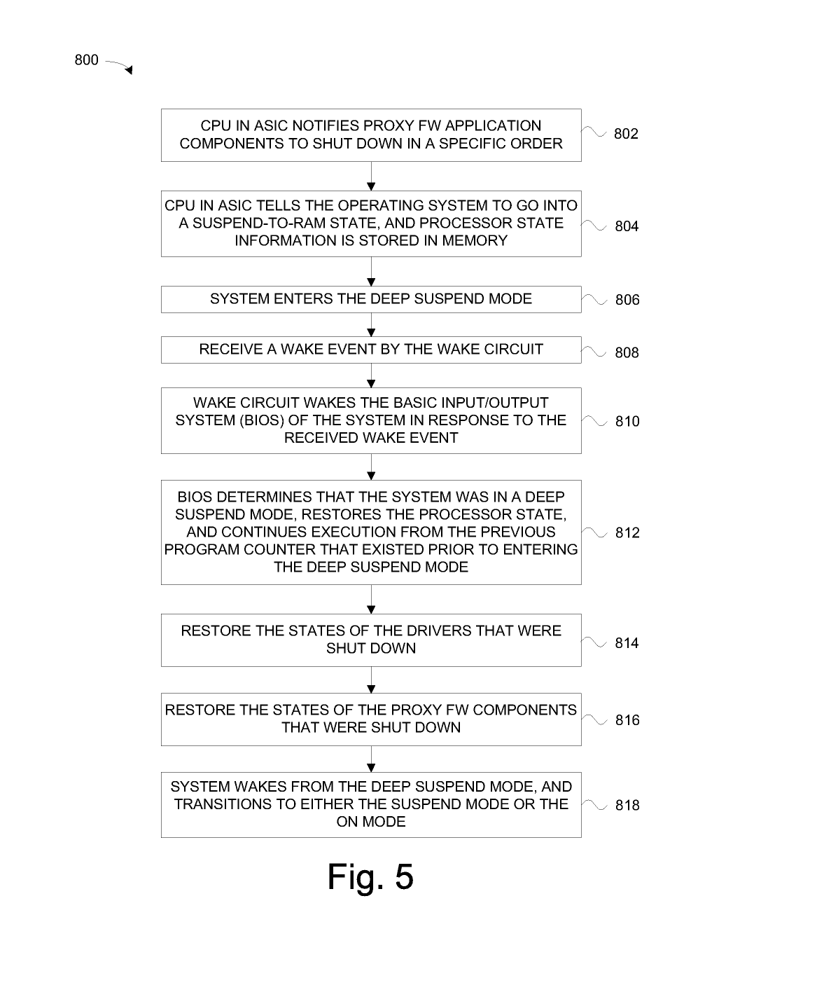

FIG. 5 is a flow diagram illustrating a method 800 of entering and exiting a deep suspend mode in an imaging system according to one embodiment. In one embodiment, system 100 is configured to perform method 800. At 802 in method 800, the CPU in ASIC 610 notifies proxy FW application components to shut down in a specific order. During this process according to one embodiment, the scanner 722, control panel 726, and other separate CPU domains, including the copy processor board, are completely shut off. The wake circuit 622, the network device 614, and the memory device 608 remain powered during this process).

At 804 in method 800, after the proxy FW application components have been shut down, the CPU in ASIC 610 tells the operating system of system 100 to go into a suspend-to-ram state, and processor state information (for the CPU in ASIC 610) is stored in memory device 608. This process flushes caches and shuts down some of the few remaining FW device drivers like SATA, USB Host, PCI, and a few others. Throughout this process, the drivers either save all state information, or they are configured to reenumerate their HW when the system 100 exits the deep suspend mode.

At 806 in method 800, the system 100 enters the deep suspend mode. In one form of this mode, all elements of system 100 are powered down except the wake circuit 622, the memory device 608 (in a self-refresh mode), and the network device 614. At 808, a wake event is received by the wake circuit 622. At 810, the wake circuit 622 wakes the basic input/output system (BIOS) of system 100 in response to the received wake event. At 812, the BIOS determines that the system 100 was in a deep suspend mode, restores the processor state, and continues execution from the previous program counter that existed prior to entering the deep suspend mode. At 814, the states of the drivers that were shut down at 804 are restored. At 816, the states of the proxy FW components that were shut down at 802 are restored. At 818, the system wakes from the deep suspend mode, and transitions to either the suspend mode (e.g., in the case where the wake event was a network I/O) or the on mode (e.g., in the case where the wake event was something other than a network I/O).

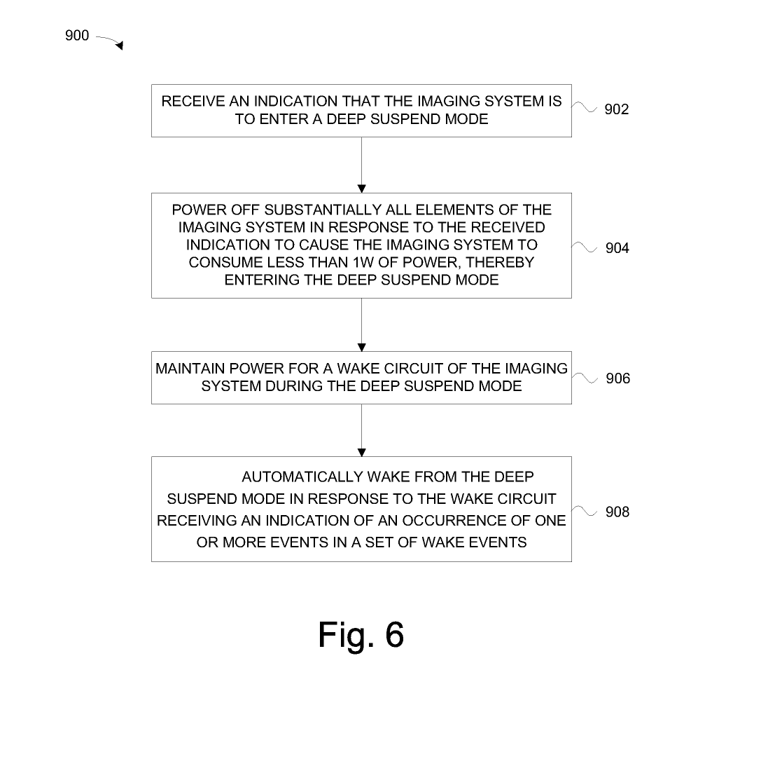

FIG. 6 is a flow diagram illustrating a method 900 of controlling a power state of an imaging system according to one embodiment. In one embodiment, imaging system 100 is configured to perform method 900. At 902 in method 900, an indication is received that the imaging system is to enter a deep suspend mode. At 904, substantially all elements of the imaging system are powered off in response to the received indication to cause the imaging system to consume less than 1 W of power, thereby entering the deep suspend mode. At 906, power is maintained for a wake circuit of the imaging system during the deep suspend mode. At 908, the imaging system automatically wakes from the deep suspend mode in response to the wake circuit receiving an indication of an occurrence of one or more events in a set of wake events.

In one embodiment of method 900, substantially all elements of the imaging system are powered off at 904 in the deep suspend mode except a real time clock, a network device configured to receive network print jobs, and the wake circuit. In one embodiment, the method 900 further includes providing a processor in the imaging system that is configured to execute a main control program for the imaging system; providing at least one memory device in the imaging system that is configured to store computer code to be executed by the processor; and maintaining the at least one memory device in a self-refresh state during the deep suspend mode to maintain state information for the processor.

In one embodiment of method 900, elements of the imaging system that are powered off in the deep suspend mode include a print application specific integrated circuit (print ASIC), control panel, print engine, fans, USB device power, USB host power, and storage drives. In another embodiment, elements of the imaging system that are powered off in the deep suspend mode further include scanner and facsimile elements.

The set of wake events in method 900 according to one embodiment includes real time clock events, network events including network print jobs, control panel activity, and user interaction with mechanical elements of the imaging system including doors, trays, and lids. In another embodiment, the set of wake events further includes scanner events and facsimile events.

In one embodiment, method 900 further includes maintaining power to a network device during the deep suspend mode, wherein the network device is configured to receive network print jobs, and programming filters of the network device to define network events that will be considered to be wake events that will cause the imaging system to exit the deep suspend mode.

One embodiment is directed to a printing system that includes a processor configured to execute a main control program for the printing system, and at least one memory device configured to store computer code to be executed by the processor. The printing system further includes a network device configured to receive network print jobs, and a wake circuit configured to cause the printing system to enter a deep suspend mode in which the printing system consumes less than about 1 W of power, and wherein the wake circuit is configured to cause the printing system to wake from the deep suspend mode in response to a set of wake events.

The printing system according to one embodiment further includes a real time clock, and substantially all elements of the printing system are powered off in the deep suspend mode except the real time clock, the network device, and the wake circuit. The at least one memory device in the printing system according to one embodiment is maintained in a self-refresh state during the deep suspend mode and maintains state information for the processor.

Elements of the printing system that are powered off in the deep suspend mode according to one embodiment include a print application specific integrated circuit (print ASIC), control panel, print engine, fans, USB device power, USB host power, and storage drives. In another embodiment, elements of the printing system that are powered off in the deep suspend mode further include scanner and facsimile elements. In one embodiment, the set of wake events for the printing system includes real time clock events, network events including network print jobs, control panel activity, and user interaction with mechanical elements of the printing system including doors, trays, and lids. In another embodiment, the set of wake events further includes scanner events and facsimile (fax) events.

In one embodiment, the network device in the printing system includes user-programmable filters to define network events that will be considered to be wake events that will cause the printing system to exit the deep suspend mode. The wake circuit of the printing system according to one embodiment is configured to control a power state of various elements of the printing system and a sequence in which the various elements are powered on and powered off.

In one embodiment, the printing system is programmable by a user to define an inactivity time period in which the system automatically enters the deep suspend mode after the defined inactivity time period. In one embodiment, the printing system is programmable by a user to define days and times at which the system will automatically enter and exit the deep suspend mode.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A printing system, comprising:
a processor to execute a main control program for the printing system;
at least one memory device to store computer code to be executed by the processor;
a network device to receive network print jobs; and
a wake circuit to cause the printing system to enter a deep suspend mode in which the printing system consumes less than about 1 W of power, and to cause the printing system to wake from the deep suspend mode in response to a set of wake events.

2. The printing system of claim 1, and further comprising:
a real time clock; and
wherein substantially all elements of the printing system are powered off in the deep suspend mode except the real time clock, the network device, and the wake circuit.

3. The printing system of claim 2, wherein the at least one memory device is maintained in a self-refresh state during the deep suspend mode and maintains state information for the processor.

4. The printing system of claim 2, wherein elements of the printing system that are powered off in the deep suspend mode include a print application specific integrated circuit (print ASIC), control panel, print engine, fans, USB device power, USB host power, and storage drives.

5. The printing system of claim 4, wherein elements of the printing system that are powered off in the deep suspend mode further include scanner and facsimile elements.

6. The printing system of claim 1, wherein the set of wake events includes real time clock events, network events including network print jobs, control panel activity, and user interaction with mechanical elements of the printing system including doors, trays, and lids.

7. The printing system of claim 6, wherein the set of wake events further includes scanner events and facsimile (fax) events.

8. The printing system of claim 1, wherein the network device comprises user-programmable filters to define network events that will be considered to be wake events that will cause the printing system to exit the deep suspend mode.

9. The printing system of claim 1, wherein the wake circuit controls a power state of various elements of the printing system and a sequence in which the various elements are powered on and powered off.

10. The printing system of claim 1, wherein the printing system is programmable by a user to define an inactivity time period in which the system automatically enters the deep suspend mode after the defined inactivity time period.

11. The printing system of claim 1, wherein the printing system is programmable by a user to define days and times at which the system will automatically enter and exit the deep suspend mode.

12. A method of controlling a power state of an imaging system, comprising:
receiving an indication that the imaging system is to enter a deep suspend mode;
powering off substantially all elements of the imaging system in response to the received indication to cause the imaging system to consume less than 1 W of power, thereby entering the deep suspend mode;
maintaining power to a wake circuit during the deep suspend mode; and
automatically waking the imaging system from the deep suspend mode in response to the wake circuit receiving an indication of an occurrence of one or more events in a set of wake events.

13. The method of claim 12, wherein substantially all elements of the imaging system are powered off in the deep suspend mode except a real time clock, a network device configured to receive network print jobs, and the wake circuit.

14. The method of claim 13, and further comprising:
providing a processor in the imaging system to execute a main control program for the imaging system;
providing at least one memory device in the imaging system to store computer code to be executed by the processor; and
maintaining the at least one memory device in a self-refresh state during the deep suspend mode to maintain state information for the processor.

15. The method of claim 13, wherein elements of the imaging system that are powered off in the deep suspend mode include a print application specific integrated circuit (print ASIC), control panel, print engine, fans, USB device power, USB host power, and storage drives.

16. The method of claim 15, wherein elements of the imaging system that are powered off in the deep suspend mode further include scanner and facsimile elements.

17. The method of claim 12, wherein the set of wake events includes real time clock events, network events including network print jobs, control panel activity, and user interaction with mechanical elements of the imaging system including doors, trays, and lids.

18. The method of claim 17, wherein the set of wake events further includes scanner events and facsimile events.

19. The method of claim 12, and further comprising:
maintaining power to a network device during the deep suspend mode, wherein the network device receives network print jobs; and
programming filters of the network device to define network events that will be considered to be wake events that will cause the imaging system to exit the deep suspend mode.

20. A printing system, comprising:
a processor to execute a main control program for the printing system;
at least one memory device to store computer code to be executed by the processor;
a real time clock;
a network device to receive network print jobs; and
a wake circuit to cause the printing system to enter a deep suspend mode in which substantially all elements of the printing system are powered off except the real time clock, the network device, and the wake circuit, and to cause the printing system to wake from the deep suspend mode in response a set of wake events.
